(19) United States
(12) Patent Application Publication
(10) Pub. No.: US 2025/0192866 A1
(43) Pub. Date: Jun. 12, 2025

(54) EXPLICIT BEAM FAILURE DETECTION REFERENCE SIGNAL ACTIVATION AND DEACTIVATION

(71) Applicant: QUALCOMM Incorporated, San Diego, CA (US)

(72) Inventors: Ruiming ZHENG, Beijing (CN); Ozcan OZTURK, San Diego, CA (US)

(21) Appl. No.: 18/842,155

(22) PCT Filed: Apr. 21, 2022
(86) PCT No.: PCT/CN2022/088076

§ 371 Date: Aug. 28, 2024

(51) Int. Cl. H04B 7/06; H04L 5/00

(52) U.S. Cl. CPC H04B 7/06964; H04L 5/0048

(57) ABSTRACT

Various aspects of the present disclosure generally relate to wireless communication. In some aspects, a user equipment (UE) may receive a medium access control (MAC) control element (MAC-CE) updating one or more beam failure detection (BFD) reference signal (BFD-RS) resources associated with at least one radio node of multiple radio nodes associated with the UE. The UE may monitor for a BFD-RS on the one or more BFD-RS resources. Numerous other aspects are described.

### FIELD OF THE DISCLOSURE

Aspects of the present disclosure generally relate to wireless communication and to techniques and apparatuses for explicit beam failure detection reference signal (BFD-RS) activation and deactivation.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a WiFi link, or a Bluetooth link).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving a medium access control (MAC) control element (MAC-CE) updating one or more beam failure detection (BFD) reference signal (BFD-RS) resources associated with at least one radio node of multiple radio nodes associated with the UE. The method may include monitoring for a BFD-RS on the one or more BFD-RS resources.

Some aspects described herein relate to a method of wireless communication performed by a network node. The method may include transmitting a MAC-CE updating one or more BFD-RS resources associated with at least one radio node of multiple radio nodes. The method may include triggering or transmitting a BFD-RS based at least in part on the one or more BFD-RS resources.

Some aspects described herein relate to a UE for wireless communication. The user equipment may include a memory and one or more processors coupled to the memory. The one or more processors may be configured to receive a MAC-CE updating one or more BFD-RS resources associated with at least one radio node of multiple radio nodes associated with the UE. The one or more processors may be configured to monitor for a BFD-RS on the one or more BFD-RS resources.

Some aspects described herein relate to a network node for wireless communication. The network node may include a memory and one or more processors coupled to the memory. The one or more processors may be configured to transmit a MAC-CE updating one or more BFD-RS resources associated with at least one radio node of multiple radio nodes. The one or more processors may be configured to trigger or transmit a BFD-RS based at least in part on the one or more BFD-RS resources.

Some aspects described herein relate to a non-transitory computer-readable medium that stores a set of instructions for wireless communication by a UE. The set of instructions, when executed by one or more processors of the UE, may cause the UE to receive a MAC-CE updating one or more BFD-RS resources associated with at least one radio node of multiple radio nodes associated with the UE. The set of instructions, when executed by one or more processors of the UE, may cause the UE to monitor for a BFD-RS on the one or more BFD-RS resources.

Some aspects described herein relate to a non-transitory computer-readable medium that stores a set of instructions for wireless communication by a network node. The set of instructions, when executed by one or more processors of the network node, may cause the network node to transmit a MAC-CE updating one or more BFD-RS resources associated with at least one radio node of multiple radio nodes. The set of instructions, when executed by one or more processors of the network node, may cause the network node to trigger or transmit a BFD-RS based at least in part on the one or more BFD-RS resources.

Some aspects described herein relate to an apparatus for wireless communication. The apparatus may include means for receiving a MAC-CE updating one or more BFD-RS resources associated with at least one radio node of multiple radio nodes associated with the UE. The apparatus may include means for monitoring for a BFD-RS on the one or more BFD-RS resources.

Some aspects described herein relate to an apparatus for wireless communication. The apparatus may include means for transmitting a MAC-CE updating one or more BFD-RS resources associated with at least one radio node of multiple radio nodes. The apparatus may include means for triggering or transmitting a BFD-RS based at least in part on the one or more BFD-RS resources.

Aspects generally include a method, apparatus, system, computer program product, non-transitory computer-readable medium, user equipment, base station, network node, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 illustrates an example of a logical architecture of a distributed radio access network (RAN) associated with beam recovery during multi transmission reception point (TRP) operation, in accordance with the present disclosure.

FIG. 4 is a diagram illustrating an example of multi-TRP communication (sometimes referred to as multi-panel communication) associated with beam recovery during multi-TRP operation, in accordance with the present disclosure.

FIG. 5 is a diagram illustrating an example of using beams for communications between a base station and a UE, associated with beam recovery during multi-TRP operation, in accordance with the present disclosure.

FIG. 6 is a diagram illustrating an example of beam failure detection (BFD) and beam failure recovery (BFR) during multi-TRP operation, in accordance with the present disclosure.

FIG. 7 is a diagram illustrating an example of medium access control (MAC) signaling of one or more BFD reference signal resources, in accordance with the present disclosure.

FIGS. 8-13 are diagrams illustrating examples of structures for a MAC control element, in accordance with the present disclosure.

FIG. 14 is a diagram illustrating an example process performed, for example, by a UE, in accordance with the present disclosure.

FIG. 15 is a diagram illustrating an example process performed, for example, by a network node, in accordance with the present disclosure.

FIG. 16 is a diagram of an example apparatus for wireless communication, in accordance with the present disclosure.

FIG. 17 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

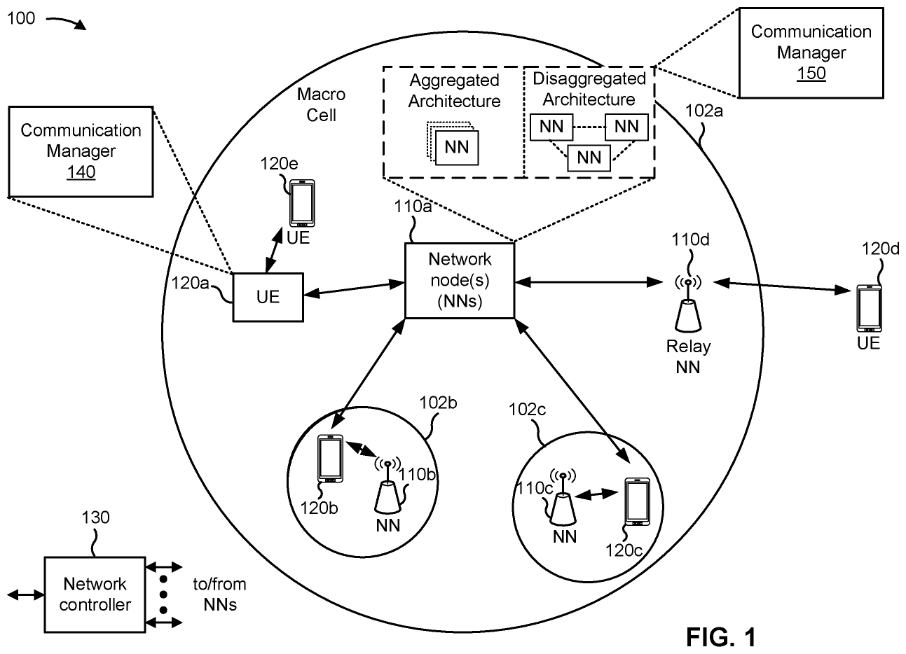

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 includes two or more non-co-located network nodes. A disaggregated network node may be configured to utilize a protocol stack that is physically or logically distributed among two or more nodes (such as one or more central units (CUs), one or more distributed units (DUs), or one or more radio units (RUS)).

In some examples, a network node 110 includes an entity that communicates with UEs 120 via a radio access link, such as an RU. In some examples, a network node 110 includes an entity that communicates with other network nodes 110 via a fronthaul link or a midhaul link, such as a DU. In some examples, a network node 110 includes an entity that communicates with other network nodes 110 via a midhaul link or a core network via a backhaul link, such as a CU. In some aspects, a network node 110 (such as an aggregated network node 110 or a disaggregated network node 110) may include multiple network nodes, such as one or more RUs, one or more CUS, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another and/or to one or more other network nodes 110 in the wireless network 100 through various types of fronthaul, midhaul, or backhaul interfaces, such as a direct physical connection, an air interface, or a virtual network, using any suitable transport network.

In some aspects, a network node 110 may provide communication coverage for a particular geographic area. In the Third Generation Partnership Project (3GPP), the term “cell” can refer to a coverage area of a base station and/or a base station subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station for a macro cell may be referred to as a macro base station. A base station for a pico cell may be referred to as a pico base station. A base station for a femto cell may be referred to as a femto base station or an in-home base station. In the example shown in FIG. 1, the network node 110a may be a macro base station for a macro cell 102a, the network node 110b may be a pico base station for a pico cell 102b, and the network node 110c may be a femto base station for a femto cell 102c. A base station may support one or multiple (e.g., three) cells.

As described herein, a node (which may be referred to as a node, a network node, a network entity, or a wireless node) may include, be, or be included in (e.g., be a component of) a network node (e.g., any network node described herein), a base station (e.g., any base station described herein), a UE (e.g., any UE described herein), a network controller, an apparatus, a device, a computing system, an integrated access and backhauling (IAB) node, a DU, a CU, an RU, and/or another processing entity configured to perform any of the techniques described herein. For example, a node may be a UE. As another example, a node may be a base station or network node. As another example, a first node may be configured to communicate with a second node or a third node. In one aspect of this example, the first node may be a UE, the second node may be a base station, and the third node may be a UE. In another aspect of this example, the first node may be a UE, the second node may be a base station, and the third node may be a base station. In yet other aspects of this example, the first, second, and third nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE being configured to receive information from a base station also discloses that a first network node being configured to receive information from a second network node, the first network node may refer to a first UE, a first base station, a first apparatus, a first device, a first computing system, a first one or more components, a first processing entity, or the like configured to receive the information; and the second network node may refer to a second UE, a second base station, a second apparatus, a second device, a second computing system, a first one or more components, a first processing entity, or the like.

In some examples, a cell may not necessarily be stationary, and the geographic area of the cell may move according to the location of a network node 110 that is mobile (e.g., a mobile base station).

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120 or network nodes 110. In the example shown in FIG. 1, the network node 110d (e.g., a relay base station) may communicate with the network node 110a (e.g., a macro base station) and the UE 120d in order to facilitate communication between the network node 110a and the UE 120d. A network node 110 that relays communications may be referred to as a relay station, a relay base station, a relay node, a relay, or the like.

The wireless network 100 may be a heterogeneous network that includes network nodes 110 of different types, such as macro base stations, pico base stations, femto base stations, relay base stations, TRPs, RUs, or the like. These different types of network nodes 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul or midhaul communication link. The network nodes 110 may communicate with one another directly or indirectly via a wireless or wireline backhaul communication link. In some aspects, the network controller 130 may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

As described herein, communication of information (e.g., any information, signal, or the like) may be described in various aspects using different terminology, such as “transmit,” “provide,” “output,” “receive” “obtain,” and “decode,” among other examples. Disclosure of one of these communication term includes disclosure of other of these communication terms. For example, a first network node 110 may be described as being configured to transmit information to a second network node 110. In this example and consistent with this disclosure, disclosure that the first network node 110 is configured to transmit information to the second network node 110 includes disclosure that the first network node 110 is configured to provide, send, output, communicate, or transmit information to the second network node 110. Similarly, in this example and consistent with this disclosure, disclosure that the first network node 110 is configured to transmit information to the second network node 110 includes disclosure that the second network node 110 is configured to receive, obtain, or decode the information that is provided, sent, output, communicated, or transmitted by the first network node 110.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FRI, FR2, FR3, FR4, FR4-a, FR4-1, and/or FR5) may be modified, and techniques described herein are applicable to those modified frequency ranges.

Deployment of communication systems, such as 5G NR systems, may be arranged in multiple manners with various components or constituent parts. In a 5G NR system, or network, a network node may be implemented in an aggregated or disaggregated architecture. For example, a network node, or one or more units (or one or more components) performing network node functionality, may be implemented as an aggregated network node (sometimes referred to as a standalone base station or a monolithic base station) or a disaggregated network node. “Network entity” or “network node” may refer to a disaggregated network node, an aggregated network node, or one or more entities of a disaggregated network node (such as one or more CUs, one or more DUs, one or more RUs, or a combination thereof).

In some aspects, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also may be implemented as virtual units (e.g., a virtual central unit (VCU), a virtual distributed unit (VDU), or a virtual radio unit (VRU)).

Base station-type operation or network design may consider aggregation characteristics of network node functionality. For example, disaggregated network nodes may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that may be individually deployed. A disaggregated network node may include functionality implemented across two or more units at various physical locations, as well as functionality implemented for at least one unit virtually, which may enable flexibility in network design.

In some aspects, the UE 120 may include a communication manager 140. As described in more detail elsewhere herein, the communication manager 140 may receive a medium access control (MAC) control element (MAC-CE) updating one or more beam failure detection (BFD) reference signal (BFD-RS) resources associated with at least one radio node of multiple radio nodes associated with the UE; and monitor for a BFD-RS on the one or more BFD-RS resources. Additionally, or alternatively, the communication manager 140 may perform one or more other operations described herein.

In some aspects, the network node may include a communication manager 150. As described in more detail elsewhere herein, the communication manager 150 may transmit a MAC-CE updating one or more BFD-RS resources associated with at least one radio node of multiple radio nodes; and trigger or transmitting a BFD-RS based at least in part on the one or more BFD-RS resources. Additionally, or alternatively, the communication manager 150 may perform one or more other operations described herein.

As indicated above, FIG. 1 is provided as an example. Other examples may differ from what is described with regard to FIG. 1.

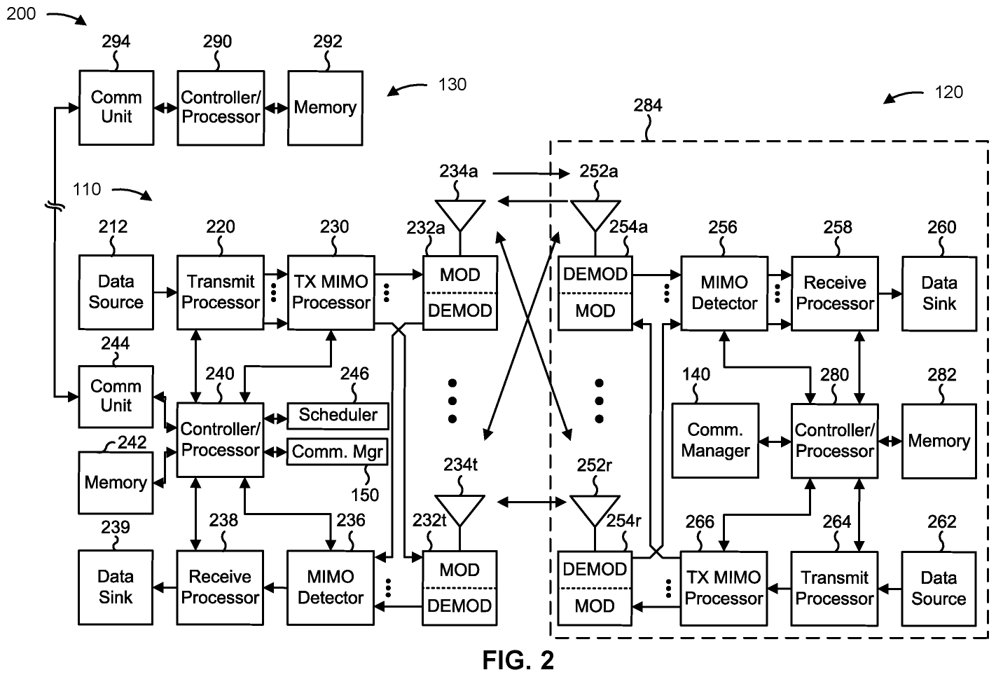

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. For example, some network nodes 110 may not include radio frequency components.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

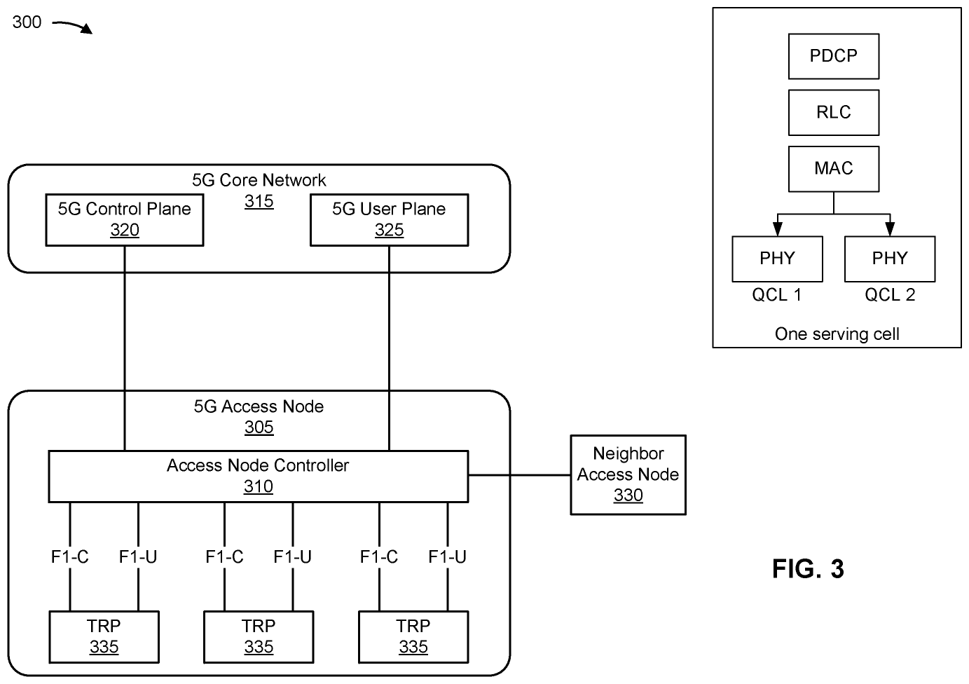

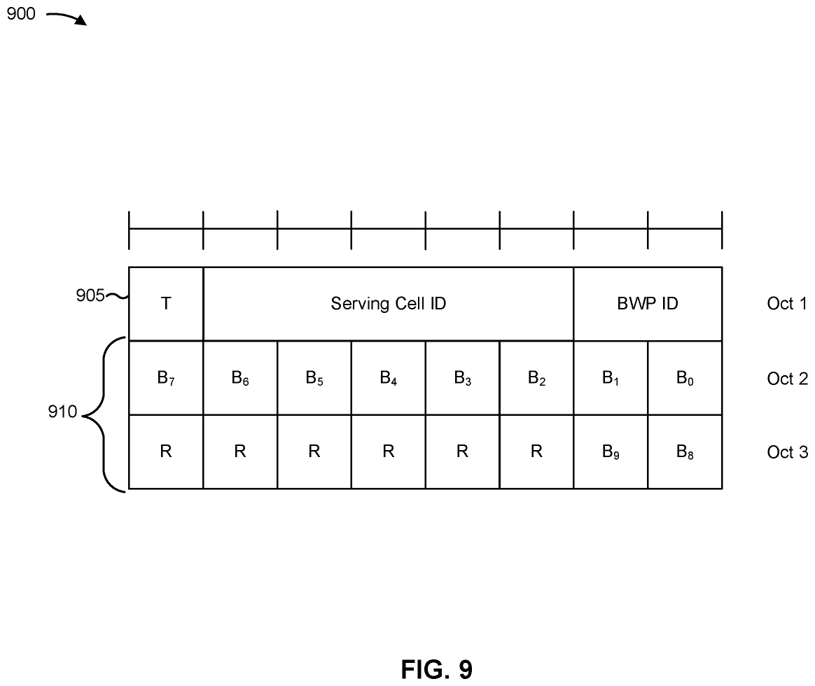

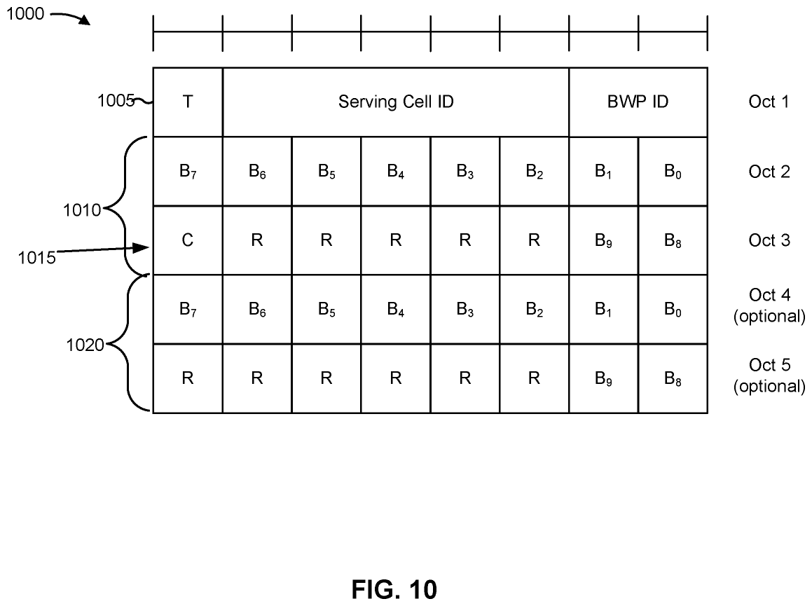

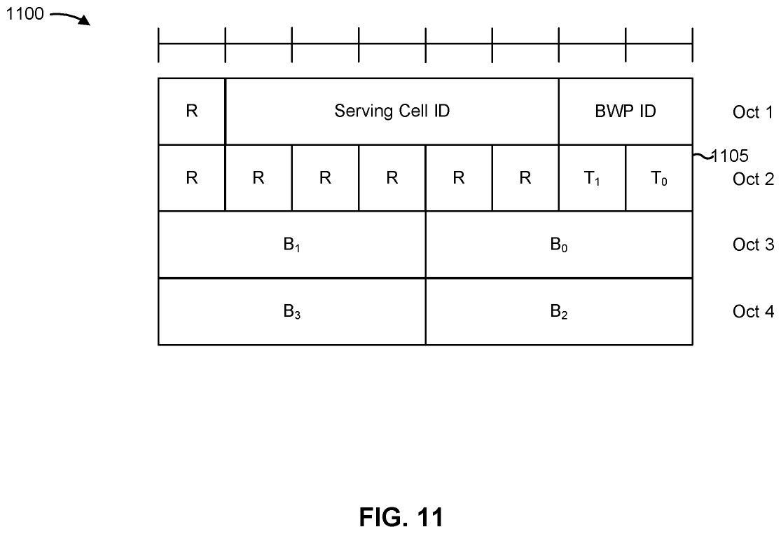

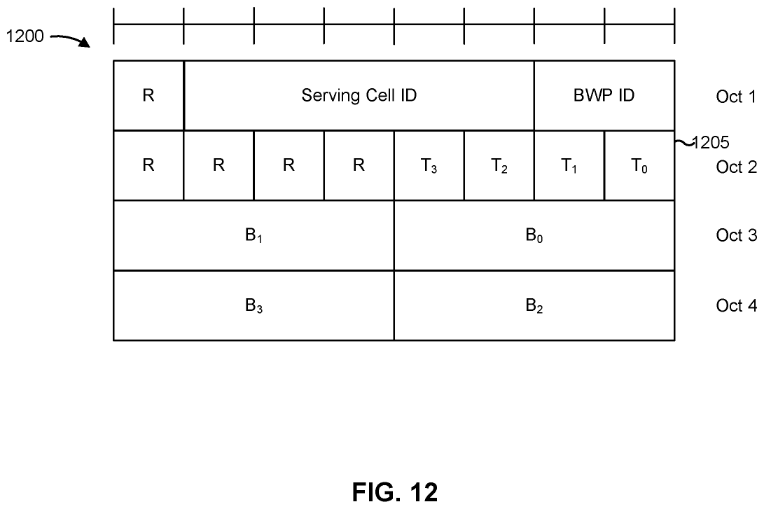

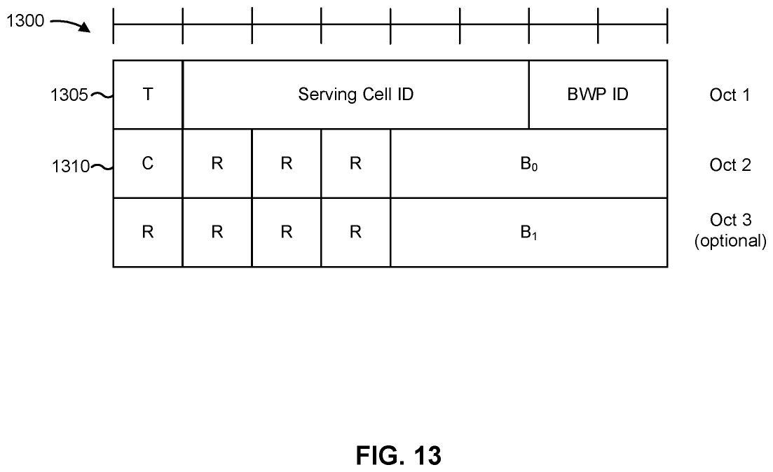

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 3-17).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 3-17).

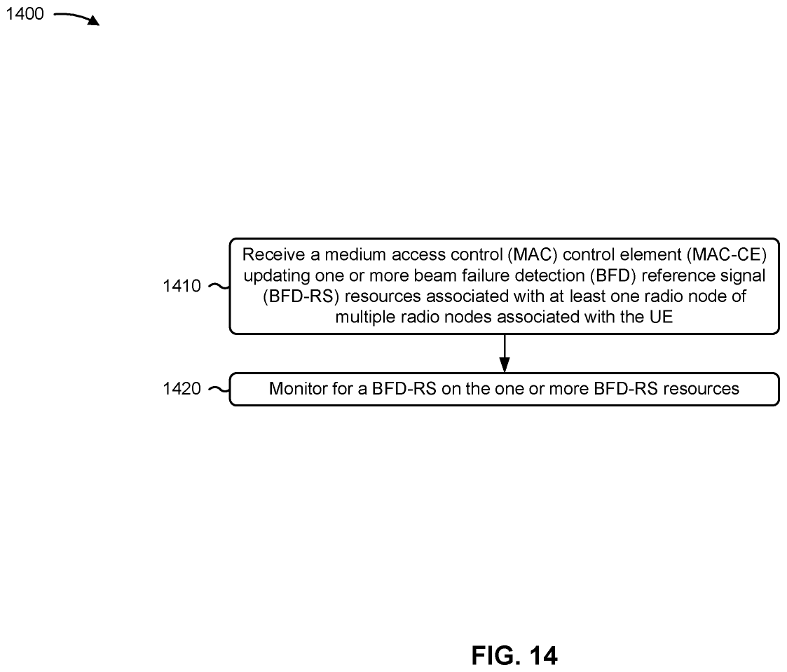

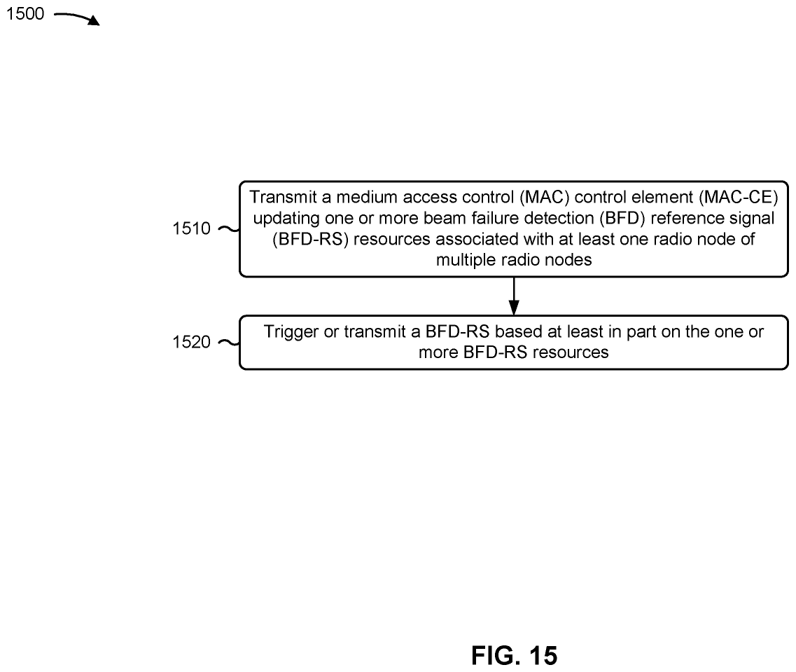

The controller/processor 240 of the network node 110, the controller/processor 280 of the UE 120, and/or any other component(s) of FIG. 2 may perform one or more techniques associated with BFD monitoring, as described in more detail elsewhere herein. For example, the controller/processor 240 of the network node 110, the controller/processor 280 of the UE 120, and/or any other component(s) of FIG. 2 may perform or direct operations of, for example, process 1400 of FIG. 14, process 1500 of FIG. 15, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1400 of FIG. 14, process 1500 of FIG. 15, and/or other processes as described herein. In some examples, executing instructions may include running the instructions, converting the instructions, compiling the instructions, and/or interpreting the instructions, among other examples.

In some aspects, the UE includes means for receiving a MAC-CE updating one or more BFD-RS resources associated with at least one radio node of multiple radio nodes associated with the UE; and/or means for monitoring for a BFD-RS on the one or more BFD-RS resources. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node includes means for transmitting a MAC-CE updating one or more BFD-RS resources associated with at least one radio node of multiple radio nodes; and/or means for triggering or transmitting a BFD-RS based at least in part on the one or more BFD-RS resources. In some aspects, the means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

FIG. 3 illustrates an example 300 of a logical architecture of a distributed RAN associated with beam recovery during multi-TRP operation, in accordance with the present disclosure. A TRP is an example of a radio node, as described elsewhere herein.

A 5G access node 305 (sometimes referred to herein as a network node or a set of network nodes) may include an access node controller 310 (sometimes referred to herein as a network node). The access node controller 310 may be a CU of the distributed RAN 300. In some aspects, a backhaul interface to a 5G core network 315 may terminate at the access node controller 310. The 5G core network 315 may include a 5G control plane component 320 and a 5G user plane component 325 (e.g., a 5G gateway), and the backhaul interface for one or both of the 5G control plane and the 5G user plane may terminate at the access node controller 310. Additionally, or alternatively, a backhaul interface to one or more neighbor access nodes 330 (e.g., another 5G access node 305, an LTE access node, and/or the like) may terminate at the access node controller 310.

The access node controller 310 may include and/or may communicate with one or more TRPs 335 (e.g., via an F1 Control (F1-C) interface and/or an F1 User (F1-U) interface). A TRP 335 may be a DU or RU of the distributed RAN 300. In some aspects, a TRP 335 may be associated with a network node 110 described above in connection with FIG. 1.

A TRP 335 may be connected to a single access node controller 310 or to multiple access node controllers 310. In some aspects, a functional split of logical functions may be implemented within the architecture of distributed RAN 300. For example, a packet data convergence protocol (PDCP) layer, a radio link control (RLC) layer, a MAC layer, and/or the like may be configured to terminate at the access node controller 310 or at a TRP 335. In some aspects, functions associated with the PDCP layer, the RLC layer, and/or the MAC layer may be controlled and/or performed by the network node 110, and functions associated with a physical layer (PHY) may be controlled and/or performed by the TRPs 335. For example, each TRP 335 may have a PHY layer entity, and MAC/RLC/PDCP entities may be implemented at the access node controller 310.

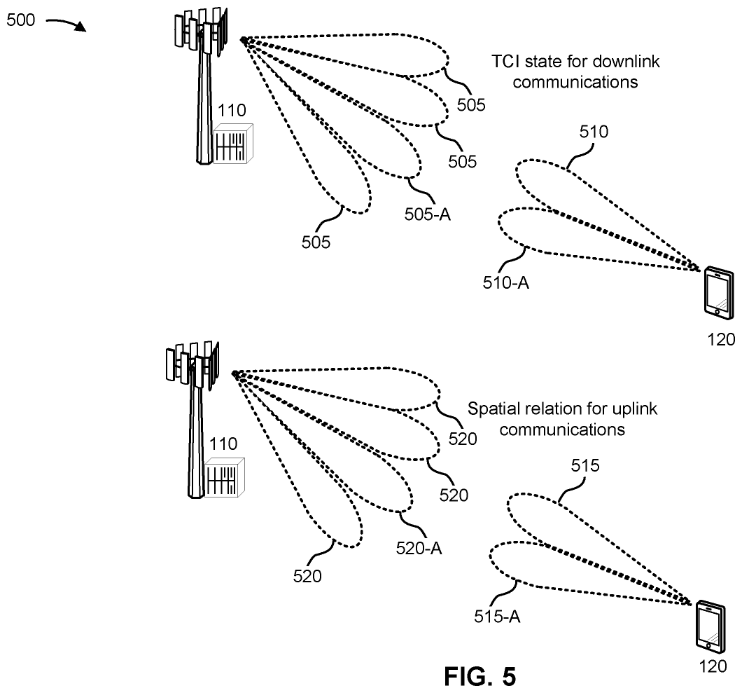

In some aspects, multiple TRPs 335 may transmit communications (e.g., the same communication or different communications) in the same transmission time interval (TTI) (e.g., a slot, a mini-slot, a subframe, a symbol, and/or the like) or different TTIs using different quasi co-location (QCL) relationships (e.g., different spatial parameters, different transmission configuration indicator (TCI) states, different precoding parameters, different beamforming parameters, and/or the like). The different QCL relationships are shown by “QCL 1” and “QCL 2” in FIG. 3. In some aspects, a TCI state may be used to indicate one or more QCL relationships, as described in connection with FIG. 5. A TRP 335 may be configured to individually (e.g., using dynamic selection) or jointly (e.g., using joint transmission with one or more other TRPs 335) serve traffic to a UE 120.

As indicated above, FIG. 3 is provided as an example. Other examples may differ from what was described with regard to FIG. 3.

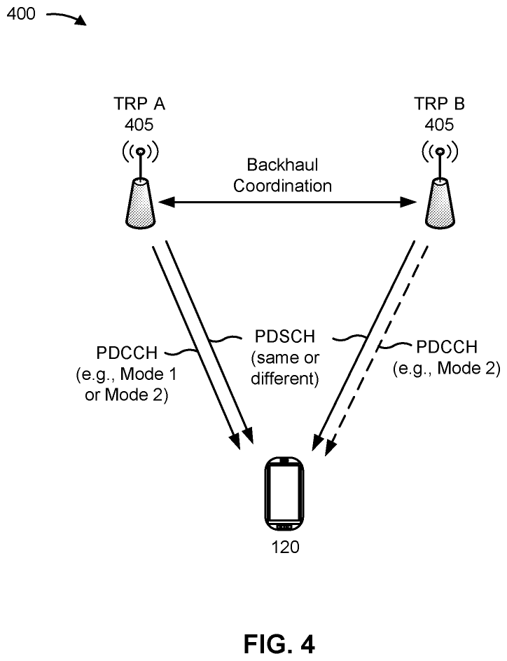

FIG. 4 is a diagram illustrating an example 400 of multi-TRP communication (sometimes referred to as multi-panel communication) associated with beam recovery during multi-TRP operation, in accordance with the present disclosure. As shown in FIG. 4, multiple TRPs 405 may communicate with the same UE 120. A TRP 405 may correspond to (e.g., be) a TRP 335 described above in connection with FIG. 3.

The multiple TRPs 405 (shown as TRP A and TRP B) may communicate with the same UE 120 in a coordinated manner (e.g., using coordinated multipoint transmissions and/or the like) which may improve reliability, increase throughput, and/or the like. The TRPs 405 may coordinate such communications via an interface between the TRPs 405 (e.g., a backhaul interface, an access node controller 310, and/or the like). The interface may have a smaller delay and/or higher capacity when the TRPs 405 are co-located at the same network node 110 (e.g., when the TRPs 405 are different antenna arrays or panels of the same network node 110), and may have a larger delay and/or lower capacity (as compared to co-location) when the TRPs 405 are located at different network nodes 110. The different TRPs 405 may communicate with the UE 120 using different QCL relationships (e.g., different TCI states), different DMRS ports, different layers (e.g., of a multi-layer communication), and/or the like.

In a first multi-TRP transmission mode (e.g., Mode 1), a beam associated with a single physical downlink control channel (PDCCH) may be used to schedule downlink data communications for a single physical downlink shared channel (PDSCH). In this case, multiple TRPs 405 (e.g., TRP A and TRP B) may transmit communications to the UE 120 on the same PDSCH. For example, a communication may be transmitted using a single codeword with different spatial layers for different TRPs 405 (e.g., where one codeword maps to a first set of layers transmitted by a first TRP 405 and maps to a second set of layers transmitted by a second TRP 405). As another example, a communication may be transmitted using multiple codewords, where different codewords are transmitted by different TRPs 405 (e.g., using different sets of layers). In either case, different TRPs 405 may use different QCL relationships (e.g., different TCI states) for different DMRS ports corresponding to different layers. For example, a first TRP 405 may use a first QCL relationship (such as QCL1 shown in FIG. 3) or a first TCI state for a first set of DMRS ports corresponding to a first set of layers, and a second TRP 405 may use a second (different) QCL relationship (such as QCL2 shown in FIG. 3) or a second (different) TCI state for a second (different) set of DMRS ports corresponding to a second (different) set of layers. In some aspects, a TCI state in downlink control information (DCI) (e.g., transmitted on the PDCCH, such as DCI format 1_0, DCI format 1_1, and/or the like) may indicate the first QCL relationship (e.g., by indicating a first TCI state) and the second QCL relationship (e.g., by indicating a second TCI state). The first and the second TCI states may be indicated using a TCI field in the DCI. In general, the TCI field can indicate a single TCI state (for single-TRP transmission) or multiple TCI states (for multi-TRP transmission as discussed here) in this multi-TRP transmission mode (e.g., Mode 1).

In a second multi-TRP transmission mode (e.g., Mode 2), multiple respective beams associated with multiple PDCCHs may be used to schedule downlink data communications for multiple corresponding PDSCHs (e.g., one PDCCH for each PDSCH). In this case, a first beam associated with a first PDCCH may be utilized to schedule a first codeword to be transmitted by a first TRP 405, and a second beam associated with a second PDCCH may be utilized to schedule a second codeword to be transmitted by a second TRP 405. Furthermore, first DCI (e.g., transmitted by the first TRP 405) may schedule a first PDSCH communication associated with a first set of DMRS ports with a first QCL relationship (e.g., indicated by a first TCI state) for the first TRP 405, and second DCI (e.g., transmitted by the second TRP 405) may schedule a second PDSCH communication associated with a second set of DMRS ports with a second QCL relationship (e.g., indicated by a second TCI state) for the second TRP 405. In this case, DCI (e.g., having DCI format 1_0, DCI format 1_1, and/or the like) may indicate a corresponding TCI state for a TRP 405 corresponding to the DCI. The TCI field of a DCI indicates the corresponding TCI state (e.g., the TCI field of the first DCI indicates the first TCI state and the TCI field of the second DCI indicates the second TCI state).

As indicated above, FIG. 4 is provided as an example. Other examples may differ from what is described with respect to FIG. 4.

FIG. 5 is a diagram illustrating an example 500 of using beams for communications between a base station and a UE, associated with beam recovery during multi-TRP operation, in accordance with the present disclosure. As shown in FIG. 5, a network node 110 and a UE 120 may communicate with one another.

The network node 110 may utilize multiple TRPs to transmit to UEs 120 located within a coverage area of the network node 110. The multiple TRPs associated with the network node 110 and the UE 120 may be configured for beamformed communications, where the multiple TRPs associated with the network node 110 may transmit in the direction of the UE 120 using one or more directional base station (BS) transmit beams, and the UE 120 may receive the transmission using one or more directional UE receive beams. Each BS transmit beam may have an associated beam ID, beam direction, or beam symbols, among other examples. The network node 110 may transmit downlink communications via one or more BS transmit beams 505.

The UE 120 may attempt to receive downlink transmissions via one or more UE receive beams 510, which may be configured using different beamforming parameters at receive circuitry of the UE 120. The UE 120 may identify a particular BS transmit beam 505, shown as BS transmit beam 505-A, and/or a particular UE receive beam 510, shown as UE receive beam 510-A, that provide relatively favorable performance (for example, that have a best channel quality of the different measured combinations of BS transmit beams 505 and UE receive beams 510). In some examples, the UE 120 may transmit an indication of which BS transmit beam 505 is identified by the UE 120 as a preferred BS transmit beam, which the network node 110 may select for transmissions to the UE 120. The UE 120 may thus attain and maintain a beam pair link (BPL) with the network node 110 for downlink communications (for example, a combination of the BS transmit beam 505-A and the UE receive beam 510-A), which may be further refined and maintained in accordance with one or more established beam refinement procedures.

A downlink beam, such as a BS transmit beam 505 or a UE receive beam 510, may be associated with a TCI state. A TCI state may indicate a directionality or a characteristic of the downlink beam, such as one or more QCL properties of the downlink beam. A QCL property may include, for example, a Doppler shift, a Doppler spread, an average delay, a delay spread, or spatial receive parameters, among other examples. In some examples, each BS transmit beam 505 may be associated with a synchronization signal block (SSB), and the UE 120 may indicate a preferred BS transmit beam 505 by transmitting uplink transmissions in resources of the SSB that are associated with the preferred BS transmit beam 505. A particular SSB may have an associated TCI state (for example, for an antenna port or for beamforming). The network node 110 may, in some examples, indicate a downlink BS transmit beam 505 based at least in part on antenna port QCL properties that may be indicated by the TCI state. A TCI state may be associated with one downlink reference signal set (for example, an SSB and an aperiodic, periodic, or semi-persistent CSI-RS) for different QCL types (for example, QCL types for different combinations of Doppler shift, Doppler spread, average delay, delay spread, or spatial receive parameters, among other examples). In cases where the QCL type indicates spatial receive parameters, the QCL type may correspond to analog receive beamforming parameters of a UE receive beam 510 at the UE 120. Thus, the UE 120 may select a corresponding UE receive beam 510 from a set of BPLs based at least in part on the network node 110 indicating a BS transmit beam 505 via a TCI indication.

The network node 110 may maintain a set of activated TCI states for downlink shared channel transmissions and a set of activated TCI states for downlink control channel transmissions. The set of activated TCI states for downlink shared channel transmissions may correspond to beams that the network node 110 and/or the multiple TRPs may use for downlink transmission on a PDSCH. The set of activated TCI states for downlink control channel communications may correspond to beams that the network node 110 and/or the multiple TRPs may use for downlink transmission on a PDCCH or in a control resource set (CORESET). The UE 120 may also maintain a set of activated TCI states for receiving the downlink shared channel transmissions and the CORESET transmissions. If a TCI state is activated for the UE 120, then the UE 120 may have one or more antenna configurations based at least in part on the TCI state, and the UE 120 may not need to reconfigure antennas or antenna weighting configurations. In some examples, the set of activated TCI states (for example, activated PDSCH TCI states and activated CORESET TCI states) for the UE 120 may be configured by a configuration message, such as a radio resource control (RRC) message.

Similarly, for uplink communications, the UE 120 may transmit in the direction of the network node 110 and/or the multiple TRPs using one or more directional UE transmit beams, and the network node 110 and/or the multiple TRPs may receive the transmission using one or more directional BS receive beams. Each UE transmit beam may have an associated beam ID, beam direction, or beam symbols, among other examples. The UE 120 may transmit uplink communications via one or more UE transmit beams 515.

The network node 110 and/or the multiple TRPs may receive uplink transmissions via one or more BS receive beams 520. The network node 110 and/or the multiple TRPs may identify a particular UE transmit beam 515, shown as UE transmit beam 515-A, and a particular BS receive beam 520, shown as BS receive beam 520-A, that provide relatively favorable performance (for example, that have a best channel quality of the different measured combinations of UE transmit beams 515 and BS receive beams 520). In some examples, the network node 110 and/or the multiple TRPs may transmit an indication of which UE transmit beam 515 is identified by the network node 110 and/or the multiple TRPs as a preferred UE transmit beam, which the network node 110 and/or the multiple TRPs may select for transmissions from the UE 120. The UE 120 and the network node 110 (and/or the multiple TRPs) may thus attain and maintain a BPL for uplink communications (for example, a combination of the UE transmit beam 515-A and the BS receive beam 520-A), which may be further refined and maintained in accordance with one or more established beam refinement procedures. An uplink beam, such as a UE transmit beam 515 or a BS receive beam 520, may be associated with a spatial relation. A spatial relation may indicate a directionality or a characteristic of the uplink beam, similar to one or more QCL properties, as described above.

As indicated above, FIG. 5 is provided as an example. Other examples may differ from what is described with respect to FIG. 5.

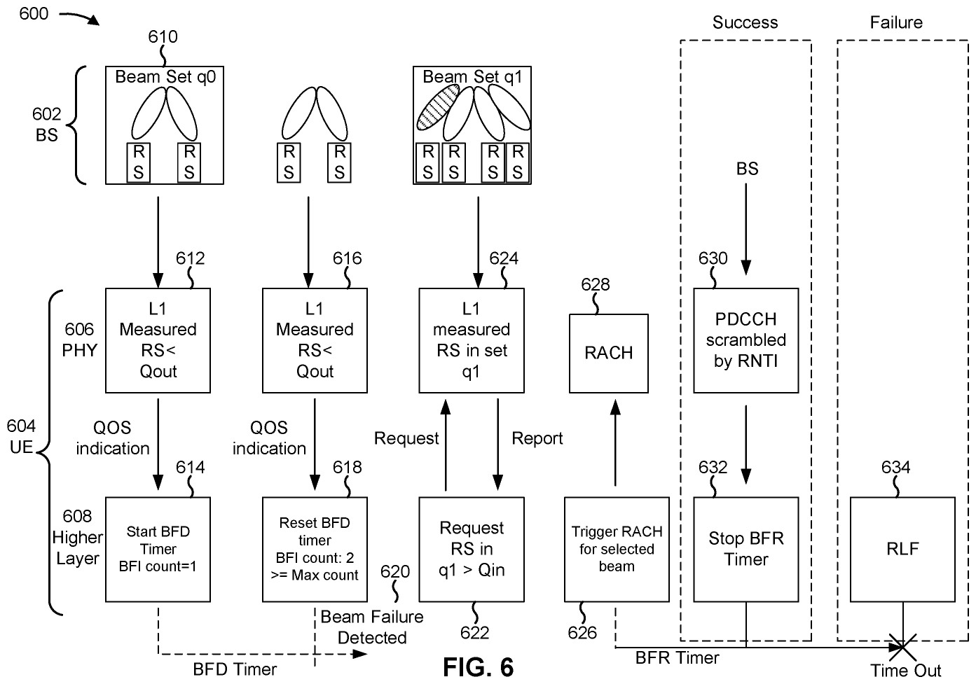

FIG. 6 is a diagram illustrating an example 600 of BFD and beam failure recovery (BFR) during multi-TRP operation, in accordance with the present disclosure. The BFD procedure is shown by reference numbers 612 through 620, and the BFR procedure is shown by reference number 622 through 634.

Example 600 includes operations performed by a network node (e.g., network node 110) and operations performed by a UE (e.g., UE 120). Operations performed by the network node are shown in the top part of FIG. 6, as shown by reference number 602. Operations performed by the UE are shown in the bottom part of FIG. 6, as shown by reference number 604. Each operation is indicated by a box, and arrows indicate a direction of an indication, a transmission, and/or the like. Actions of the UE that are performed by a PHY layer of the UE are shown in the row indicated by reference number 606, and actions of the UE that are performed by a higher layer (e.g., MAC, RLC, PDCP, RRC, non access stratum (NAS), Internet Protocol (IP), and/or the like) are shown in the row indicated by reference number 608.

As shown by reference number 610, the network node may transmit a beam set q0. The beam set q0 may include one or more beams that are each associated with a corresponding reference signal (RS), sometimes referred to herein as a BFD-RS. The reference signal may include an SSB, a CSI-RS, and/or the like. In some aspects, the network node may transmit the beam set q0 based at least in part on a failure detection CORESET, such as a half-duplex failure detection CORESET or a full duplex failure detection CORESET. For example, the network node may select the beams of the beam set q0 and/or control channels on which the respective reference signals of the beams are to be transmitted, based at least in part on the failure detection CORESET. The network node may configure the UE with BFD-RSs including the SSB or the CSI-RS. The BFD-RSs may be used to detect beam failure and/or cell-level radio link failure (RLF), as described below. For example, the network node may configure BFD-RS resources that the UE may monitor for such BFD-RSs. If no reference signals are configured for the purpose of BFD, the UE may perform beam monitoring based on the activated TCI state for the UE's UE-specific PDCCH. The TCI state indication for the UE-specific PDCCH can be updated by MAC signaling, such as via a MAC-CE. When the TCI state for the UE-specific PDCCH has already been updated via MAC-CE, the BFD-RSs configured via RRC signaling may not be suitable for BFD. However, RRC signaling is associated with a longer latency and more overhead than MAC signaling, so it may introduce latency and overhead to update the BFD-RSs via RRC signaling each time the UE-specific PDCCH's TCI state is updated via MAC signaling.

The network node may support per-TRP BFR. For example, a first set of BFD-RS resources may be configured via RRC signaling for BFD associated with a first TRP, and a second set of BFD-RS resources may be configured via RRC signaling for BFD associated with a second TRP. The maximum number of BFD-RS resources per set may be based on a network configuration. The network node may activate one or more (e.g., one or two) BFD-RS resources for a TRP. Once a BFD-RS resource is activated, the UE may perform BFD according to the operations described with regard to FIG. 6 by performing L1 measurements on the BFD-RS resource. The maximum number of activated BFD-RS resources per TRP may be based on a capability of the UE. As mentioned above, the RRC configuration of BFD-RS resources per TRP may introduce latency and overhead.

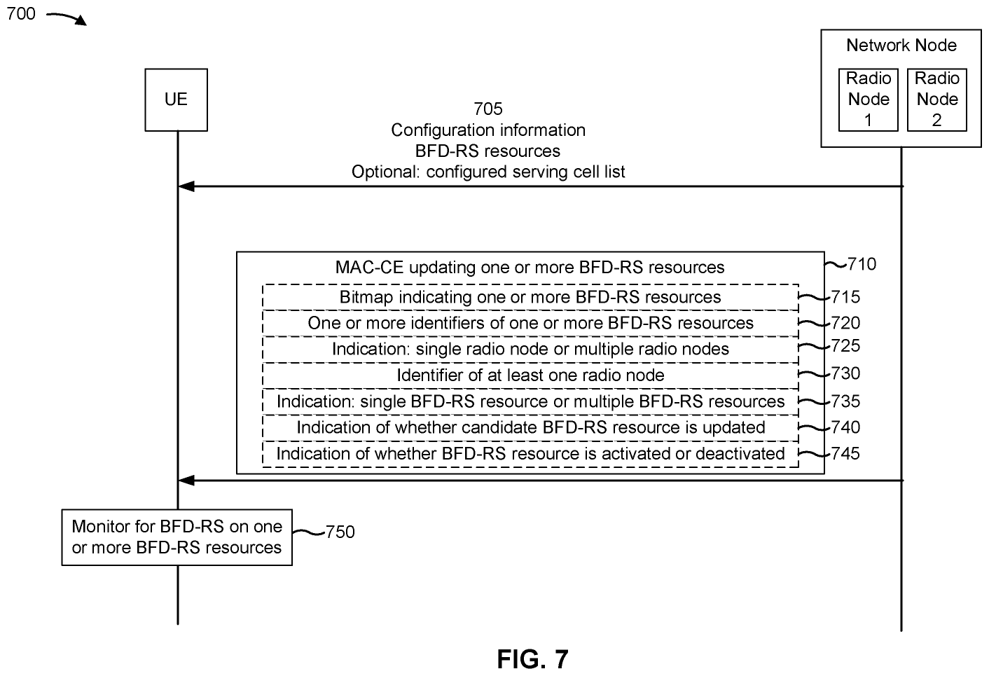

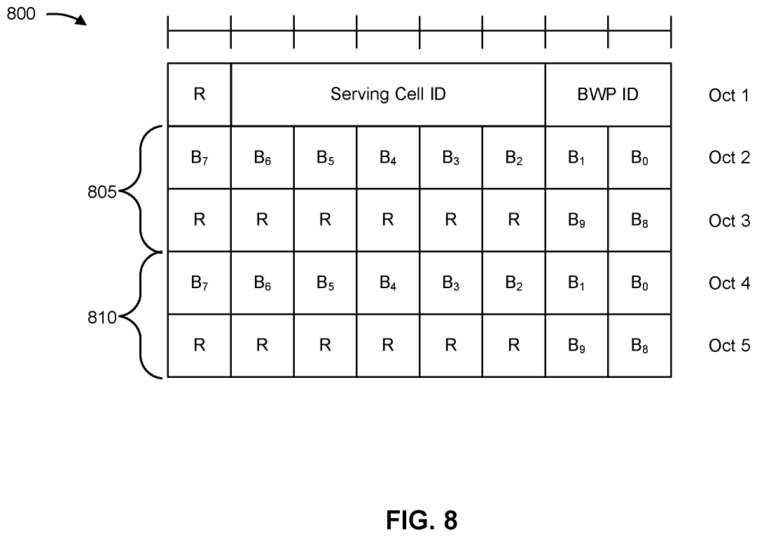

Techniques described herein provide MAC signaling to update (e.g., activate, deactivate, select) one or more BFD-RS resources of a single TRP or multiple TRPs. For example, techniques and apparatuses described herein provide MAC-CE structures that facilitate updating of BFD-RS resources for one or more TRPs of a multi-TRP deployment. Signaling associated with such a MAC-CE structure is described in more detail in connection with FIG. 7, and examples of the MAC-CE structure are provided in FIGS. 8-13. In this way, overhead and latency are reduced relative to RRC configuration based updating of active BFD-RS resources, and MAC based multi-TRP BFD-RS activation and deactivation are enabled.

As shown by reference number 612, the UE may perform a Layer 1 (L1) measurement of the reference signals of the beam set q0. For example, the UE may determine a measurement regarding each reference signal of the beam set q0 on a BFD-RS resource configured by the network node. The measurement may include a reference signal received power, a reference signal received quality, a signal to interference and noise ratio, and/or the like. As further shown, the UE (e.g., the PHY layer) may determine that the L1 measurement fails to satisfy a first threshold, referred to as Qout. Qout may be defined based at least in part on the level at which the downlink radio link cannot be reliably received, indicating that the UE is out of sync with the network node. In some aspects, Qout may be based at least in part on an out-of-sync block error rate (BLERout). In some aspects, Qout may be based at least in part on an uplink channel parameter of the UE, as described in more detail elsewhere herein. As shown, the UE (e.g., the physical layer) may provide a quality of service (QOS) indication to a higher layer of the UE.

As shown by reference number 614, the UE (e.g., the higher layer) may start a BFD timer based at least in part on the failure of the beams to satisfy Qout and may increment a beam failure indication (BFI) count. If the BFI count satisfies a threshold (shown as max count in connection with reference number 618) before the expiration of the BFD timer, then the UE may determine beam failure. If the BFD timer expires before the BFI count satisfies the threshold, then the UE may reset the BFI count, thereby not determining a beam failure.

As shown by reference number 616, the UE (e.g., the PHY layer) may perform a second L1 measurement of the reference signals of the beam set q0, such as on a configured BFD-RS resource. As further shown, the UE may provide a QOS indication to the higher layer of the UE indicating that the second L1 measurement fails to satisfy Qout. If the second L1 measurement had satisfied Qout, then the BFD timer may expire, and the UE may not identify beam failure.

As shown by reference number 618, the UE may reset the BFD timer based at least in part on the second L1 measurement failing to satisfy the threshold and may increment the BFI count. As further shown, the BFI count now satisfies the maximum count threshold. Accordingly, as shown by reference number 620, the UE determines that beam failure is detected.

As shown by reference number 622, the UE (e.g., the higher layer) may request measurement of reference signals on a beam set q1 to identify one or more beams of the beam set q1 that satisfy a second threshold (e.g., Qin). For example, the beam set q1 may be a set of candidate beams for the beam failure recovery procedure. Qin may be defined based at least in part on a level at which the downlink radio quality can be significantly more reliably received than at Qout. In some aspects, Qin may be based at least in part on an in-sync block error rate (BLERin). In some aspects, Qin may be based at least in part on an uplink transmission parameter, as described in more detail elsewhere herein.

As shown by reference number 624, the UE 120 (e.g., the PHY layer) may provide measurement information identifying L1 measurements of reference signals of the beam set q1. Assume that the measurement information indicates that a particular reference signal associated with a particular beam satisfies Qin. In FIG. 6, the particular beam is illustrated by diagonal hatching. In that case, the UE 120 may select the particular beam as a selected beam and may attempt to access the selected beam (sometimes referred to as “RACH-ing onto” the selected beam). For example, as shown by reference number 626, the UE (e.g., the higher layer) may trigger a random access channel (RACH) procedure to access the selected beam, and, as shown by reference number 628, the UE (e.g., the PHY layer) may perform the RACH procedure. For example, the UE may provide a RACH Message 1 to the network node to access the selected beam.

In the case wherein the RACH procedure is successful, the network node may provide a PDCCH on the selected beam, as shown by reference number 630. In some aspects, this response may be a response to the RACH Message 1, such as a RACH Message 2, and/or the like. As further shown, the PDCCH may be scrambled using a radio network temporary identifier (RNTI) (e.g., a cell-specific RNTI or another type of RNTI). As shown by reference number 632, the UE may stop the BFR timer based at least in part on the beam failure recovery being successful.

In the case wherein the RACH procedure is unsuccessful, the UE may determine RLF after expiration of the BFR timer, as shown by reference number 634. In such a case, the UE may enter an idle mode, may report the radio link failure, may search for a new cell, and/or the like.

As indicated above, FIG. 6 is provided as an example. Other examples may differ from what was described with respect to FIG. 6.

FIG. 7 is a diagram illustrating an example 700 of MAC signaling of one or more BFD-RS resources, in accordance with the present disclosure. As shown, example 700 includes a UE (e.g., UE 120) and a network node (e.g., network node 110, access node controller 310, TRP 335, TRP 405, a CU, a DU, an RU). As further shown, the network node may be associated with multiple radio nodes, including a first radio node (e.g., a first TRP, a first RU) and a second radio node (e.g., a second TRP, a second RU).

As shown in FIG. 7, and by reference number 705, the UE may receive configuration information (e.g., RRC signaling) configuring a first set of BFD-RS resources for the first radio node and a second set of BFD-RS resources for the second radio node. For example, the configuration may include a list of sets of BFD-RS resources per radio node of the multiple radio nodes. In some aspects, the configuration information may indicate identifiers associated with the sets of BFD-RS resources (e.g., one identifier per BFD-RS resource, one identifier per BFD-RS resource associated with a particular radio node).

In some aspects, the configuration information may include a configured serving cell list. A configured serving cell list may identify a set of serving cells (such as based at least in part on cell identifiers of the set of serving cells). In some aspects, the configured serving cell list

may identify the set of serving cells based at least in part on respective serving cell indexes of the set of serving cells. If the UE receives a MAC-CE updating a BFD-RS resource for any serving cell identified by the configured serving cell list, the UE may update the BFD-RS resource for all serving cells identified by the configured serving cell lists.

As shown in FIG. 7, and by reference number 710, the network node may transmit, and UE may receive, a MAC-CE updating one or more BFD-RS resources associated with at least one radio node, of the first radio node and the second radio node. The MAC-CE may include one or more fields selected from fields shown by reference numbers 715, 720, 725, 730, 735, 740, and 745. Example structures for the MAC-CE are shown in FIGS. 8-13. As mentioned, the MAC-CE may update one or more BFD-RS resources. “Updating a BFD-RS resource” can include activating a BFD-RS resource of a group of BFD-RS resources, or deactivating the BFD-RS resource of the group of BFD-RS resources. In example 700, the one or more BFD-RS resources are activated for the group of BFD-RS resources, such that the UE commences monitoring for BFD using the one or more BFD-RS resources. The one or more BFD-RS resources can be updated for a single radio node (e.g., either the first radio node or the second radio node) or for multiple radio nodes (e.g., the first radio node and the second radio node). Furthermore, the MAC-CE can update one or more BFD-RS resources for the first radio node and one or more BFD-RS resources for the second radio node, as described below. In some aspects, the MAC-CE is referred to as a first MAC-CE.

As shown by reference number 715, in some aspects, the MAC-CE includes a bitmap indicating the one or more BFD-RS resources. For example, for a radio node, the bitmap may include a number of bit positions corresponding to a number of configured BFD-RS resources of a set of BFD-RS resources associated with the radio node. A first value (e.g., 1) in a bit position corresponding to a particular BFD-RS resource may activate the particular BFD-RS resource for BFD monitoring. A second value (e.g., 0) in the bit position may deactivate the particular BFD-RS resource.

As shown by reference number 720, in some aspects, the MAC-CE includes one or more identifiers of the one or more BFD-RS resources. For example, a configured set of BFD-RS resources may be configured with a set of identifiers (e.g., one identifier per BFD-RS resource). The MAC-CE may include a field that indicates an identifier configured for a BFD-RS resource to be activated. If the MAC-CE does not include an identifier configured for a particular BFD-RS resource, then the particular BFD-RS resource may be deactivated (or may remain inactive).

As shown by reference number 725, in some aspects, the MAC-CE indicates whether the one or more BFD-RS resources are updated for a single radio node or for the multiple radio nodes. For example, in some cases, the MAC-CE may update one or more BFD-RS resources for a first radio node and one or more BFD-RS resources for a second radio node. In other cases, the MAC-CE may update one or more BFD-RS resources for only one radio node. In some aspects, a first value in a field of the MAC-CE may indicate that the MAC-CE updates BFD-RS resources for multiple radio nodes, and a second value in the field may indicate that the MAC-CE updates BFD-RS resources for a single radio node.

As shown by reference number 730, in some aspects, the MAC-CE identifies the at least one radio node. For example, a field of the MAC-CE may indicate the radio node for which the one or more BFD-RS resources are updated. A first value of the field may indicate the first radio node, and a second value of the field may indicate the second radio node.

As shown by reference number 735, in some aspects, the MAC-CE includes an indication of whether the one or more BFD-RS resources include a single BFD-RS resource or multiple BFD-RS resources. For example, in some cases, the MAC-CE may update a single BFD-RS resource for a radio node, whereas in other cases, the MAC-CE may update multiple BFD-RS resources for the radio node. The MAC-CE may include a field that indicates whether MAC-CE includes an identifier of a single BFD-RS resource for the radio node, or a first identifier of a first BFD-RS resource and a second identifier of a second BFD-RS resource for the radio node.

As shown by reference number 740, in some aspects, the MAC-CE includes an indication of whether a candidate BFD-RS resource, associated with a particular radio node, is updated. For example, in some cases, a first radio node can be associated with a first BFD-RS resource and a second BFD-RS resource. The MAC-CE can update one or both of the first BFD-RS resource or the second BFD-RS resource for the first radio node. The MAC-CE may include a first field indicating whether the first BFD-RS resource is updated for the first radio node and a second field indicating whether the second BFD-RS resource is updated for the first radio node. Furthermore, the MAC-CE may include a third field indicating whether a first BFD-RS resource is updated for a second radio node and a fourth field indicating whether a fourth BFD-RS resource is updated for the second radio node.

As shown by reference number 745, in some aspects, the MAC-CE includes an indication of whether a selected BFD-RS resource (as indicated by a bitmap or an identifier associated with the selected BFD-RS resource) is activated or deactivated. For example, a field of the MAC-CE including an indication set to a first value may indicate that the selected BFD-RS resource is activated, and the field including the indication set to a second value may indicate that the selected BFD-RS resource is deactivated.

In some aspects, the network node may use RRC signaling to reconfigure or update (e.g., activate or deactivate) a first set of BFD-RS resources for a first radio node and/or a second set of BFD-RS resources for a second radio node. For example, the network node may use RRC signaling if no MAC-CE signaling is configured.

As shown by reference number 750, the UE may monitor for a BFD-RS on the one or more BFD-RS resources. For example, if the MAC-CE activates the one or more BFD-RS resources, the UE may monitor for a BFD-RS on the one or more BFD-RS resources by performing L1 measurements on the one or more BFD-RS resources, as described in connection with reference numbers 612 and 616 of FIG. 6. If the MAC-CE deactivates a BFD-RS resource, the UE may cease performing L1 measurements on the deactivated BFD-RS resource. In this way, the MAC-CE can activate or deactivate a BFD-RS resource for one or two radio nodes, which enables management of BFD-RS resources on a shorter timescale than RRC based activation or deactivation of BFD-RS resources.

As indicated above, FIG. 7 is provided as an example. Other examples may differ from what is described with regard to FIG. 7.

FIGS. 8-13 are diagrams illustrating examples 800, 900, 1000, 1100, 1200, and 1300 of structures for the MAC-CE shown by reference number 710, in accordance with the present disclosure. Each of examples 800, 900, 1000, 1100, 1200, and 1300 indicate a bandwidth part identifier (which may indicate a bandwidth part associated with one or more BFD-RS resources indicated by the MAC-CE) and a serving cell identifier (which may indicate a serving cell associated with one or more BFD-RS resources indicated by the MAC-CE). “R” generally denotes a reserved bit. “B” generally denotes an indication of a BFD-RS resource (either an identifier associated with the BFD-RS resource or a bit corresponding to the BFD-RS resource). Each MAC-CE structure of examples 800-1300 is 8 bits wide, and a number of bits occupied by a field is indicated by how wide the field is. For example, a serving cell identifier occupies 5 bits, whereas each reserved bit occupies 1 bit. “Oct” is an abbreviation of “octet.” “Optional” indicates that a particular octet may or may not be included in a MAC-CE such as based at least in part on a remainder of the MAC-CE or the information indicated by the MAC-CE. In some examples (not illustrated in FIGS. 8-13), a MAC-CE may include an indication of whether a selected BFD-RS resource is activated or deactivated. For example, a bit of a MAC-CE may indicate whether all selected BFD-RS resources indicated by the MAC-CE are activated or deactivated. As another example, a bit of a MAC-CE may indicate whether one or more selected BFD-RS resources indicated by the MAC-CE are activated or deactivated (such as a particular BFD-RS resource, one or more BFD-RS resources associated with a particular radio node, or the like).

Example 800 is an example of a bitmap based MAC-CE, as described with regard to reference number 715. In example 800, the MAC-CE is able to update BFD-RS resources for two radio nodes. A first bitmap 805 indicates whether BFD-RS resource i (where in example 800, i can be 0 through 9, inclusive) is activated or deactivated for a first radio node, and a second bitmap 810 indicates whether BFD-RS resource i (where in example 800, i can be 0 through 9, inclusive) is activated or deactivated for a second radio node. A bit Bᵢ of the first bitmap 805 set to a first value activates a BFD-RS resource i for the first radio node, and the bit Bᵢ of the first bitmap 805 set to a second value deactivates the BFD-RS resource i for the first radio node. In examples 800-1300, the number of BFD-RS resources that can be updated per radio node (e.g., the number of BFD-RS resources that can be activated at once) may be based at least in part on a capability signaled by a UE. For example, the UE may signal the capability, and the network node may configure the number of BFD-RS resources updated per radio node in the MAC-CE accordingly.

Example 900 is an example of a bitmap based MAC-CE, as described with regard to reference number 715. In example 900, the MAC-CE updates BFD-RS resources for a single radio node. The single radio node may be identified by a field T, as shown by reference number 905, and as was described with regard to reference number 730 of FIG. 7. For example, the field T set to a first value may indicate to update BFD-RS resources for a first radio node, and the field T set to a second value may indicate to update BFD-RS resources for a second radio node. A bitmap 910 indicates whether BFD-RS resource i (where in example 900, i can be 0 through 9, inclusive) is updated for the single radio node. In some aspects, a bit of the MAC-CE may indicate whether BFD-RS resources indicated by the bitmap 910 are activated or deactivated.

Example 1000 is an example of a bitmap based MAC-CE, as described with regard to reference number 715. In example 1000, the MAC-CE is able to update BFD-RS resources for two radio nodes. A field T (shown by reference number 1005) may indicate whether the MAC-CE updates BFD-RS resources for a single radio node or for multiple radio nodes, as described with regard to reference number 725 of FIG. 7. A bitmap 1010 indicates whether BFD-RS resource i (where in example 1000, i can be 0 through 9, inclusive) is activated or deactivated for a first radio node. A field C (shown by reference number 1015) may identify the first radio node, as described in connection with reference number 730 of FIG. 7. If the field T indicates that the MAC-CE updates BFD-RS resources for two radio nodes, the field C may be omitted. A second bitmap 1020 (if included) may indicate whether BFD-RS resource i (where in example 1000, i can be 0 through 9, inclusive) is activated or deactivated for a second radio node of the multiple radio nodes.

Example 1100 is an example of a MAC-CE based at least in part on identifiers of BFD-RS resources, as described with regard to reference number 720. In example 1100, the MAC-CE is able to update BFD-RS resources for two radio nodes. A field Tᵢ (where T₀ is shown by reference number 1105) may indicate whether the MAC-CE updates one BFD-RS or two BFD-RSs for the ith radio node, as described in connection with reference number 735. A field B₀ may indicate an identifier of a first BFD-RS resource for a first radio node (associated with T₀), a field Bᵢ (if present) may indicate an identifier of a second BFD-RS resource for the first radio node (associated with T₀), a field B₂ (if present) may indicate an identifier of a first BFD-RS resource for the second radio node (associated with T₁), and a field B₃ may indicate an identifier of a second BFD-RS resource for the second radio node (associated with T₁). In some aspects, the MAC-CE of example 1100 may always update at least one BFD-RS for both of the first radio node and the second radio node.

Example 1200 is an example of a MAC-CE based at least in part on identifiers of BFD-RS resources, as described with regard to reference number 720. In example 1200, a field T (shown by reference number 1205) may indicate whether each corresponding BFD-RS resource of the first radio node or the second radio node is updated, as described in connection with reference number 740. For example, a field T₀ may indicate whether a first BFD-RS resource (corresponding to a field B₀) for a first radio node is updated, a field T₁ may indicate whether a second BFD-RS resource (corresponding to a field B₁) for the first radio node is updated, a field T₂ may indicate whether a first BFD-RS resource (corresponding to a field B₂) for a second radio node is updated, and a field T₃ may indicate whether a second BFD-RS resource (corresponding to a field B₃) for the second radio node is updated. Thus, the network node can selectively update one or more BFD-RS resources of the UE.

Example 1300 is an example of a MAC-CE based at least in part on identifiers of BFD-RS resources, as described with regard to reference number 720. In example 1300, the MAC-CE updates BFD-RS resources for a single radio node. A field T (shown by reference number 1305) may identify the single radio node, as described in more detail in connection with reference number 730. A field C (shown by reference number 1310) indicates whether the MAC-CE updates a single BFD-RS resource or multiple BFD-RS resources, as described in connection with reference number 735.

As indicated above, FIGS. 8-13 are provided as examples. Other examples may differ from what is described with regard to FIGS. 8-13.

FIG. 14 is a diagram illustrating an example process 1400 performed, for example, by a UE, in accordance with the present disclosure. Example process 1400 is an example where the UE (e.g., UE 120) performs operations associated with explicit beam failure detection reference signal activation and deactivation.

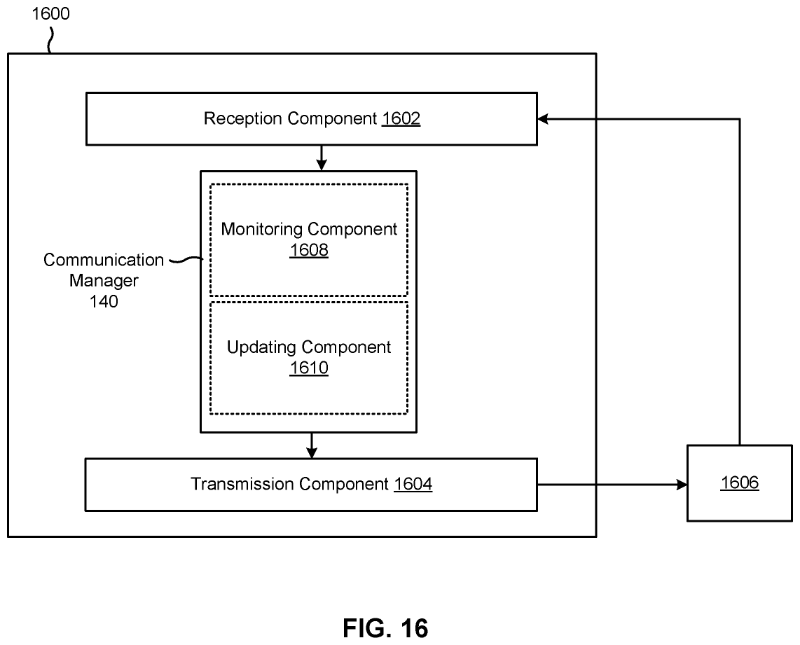

As shown in FIG. 14, in some aspects, process 1400 may include receiving MAC-CE updating one or more BFD-RS resources associated with at least one radio node of multiple radio nodes associated with the UE (block 1410). For example, the UE (e.g., using communication manager 140 and/or reception component 1602, depicted in FIG. 16) may receive a MAC-CE updating one or more BFD-RS resources associated with at least one radio node of multiple radio nodes associated with the UE, as described above. The multiple radio nodes may be associated with the UE based at least in part on the UE being configured with BFD-RS resources for each of the multiple radio nodes.

As further shown in FIG. 14, in some aspects, process 1400 may include monitoring for a BFD-RS on the one or more BFD-RS resources (block 1420). For example, the UE (e.g., using communication manager 140 and/or monitoring component 1608, depicted in FIG. 16) may monitor for a BFD-RS on the one or more BFD-RS resources, as described above.

Process 1400 may include additional aspects, such as any single aspect or any combination of aspects described below and/or in connection with one or more other processes described elsewhere herein.

In a first aspect, process 1400 includes receiving configuration information configuring a first set of BFD-RS resources for a first radio node of the multiple radio nodes and a second set of BFD-RS resources for a second radio node of the multiple radio nodes.

In a second aspect, alone or in combination with the first aspect, the configuration information includes a list of sets of BFD-RS resources per radio node of the multiple radio nodes.

In a third aspect, alone or in combination with one or more of the first and second aspects, the MAC-CE includes a bitmap indicating the one or more BFD-RS resources.

In a fourth aspect, alone or in combination with one or more of the first through third aspects, the MAC-CE includes one or more identifiers of the one or more BFD-RS resources.

In a fifth aspect, alone or in combination with one or more of the first through fourth aspects, the MAC-CE indicates whether the one or more BFD-RS resources are updated for a single radio node or for the multiple radio nodes.

In a sixth aspect, alone or in combination with one or more of the first through fifth aspects, the MAC-CE identifies the at least one radio node.

In a seventh aspect, alone or in combination with one or more of the first through sixth aspects, the MAC-CE includes an indication of whether the one or more BFD-RS resources include a single BFD-RS resource or multiple BFD-RS resources.

In an eighth aspect, alone or in combination with one or more of the first through seventh aspects, the MAC-CE includes an indication of whether a candidate BFD-RS resource, associated with a particular radio node, is updated.

In a ninth aspect, alone or in combination with one or more of the first through eighth aspects, process 1400 includes updating the one or more BFD-RS resources for a set of serving cells including at least one of a serving cell indicated by the MAC-CE, or one or more other serving cells indicated by a configured serving cell list.

In a tenth aspect, alone or in combination with one or more of the first through ninth aspects, the serving cell indicated by the MAC-CE is indicated by the configured serving cell list.

In an eleventh aspect, alone or in combination with one or more of the first through tenth aspects, process 1400 includes receiving, prior to updating the one or more BFD-RS resources, RRC signaling indicating the configured serving cell list.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram illustrating an example process 1500 performed, for example, by a network node, in accordance with the present disclosure. Example process 1500 is an example where the network node (e.g., network node 110, access node controller 310, TRP 335, TRP 405, the network node of FIG. 7) performs operations associated with explicit beam failure detection reference signal activation and deactivation.

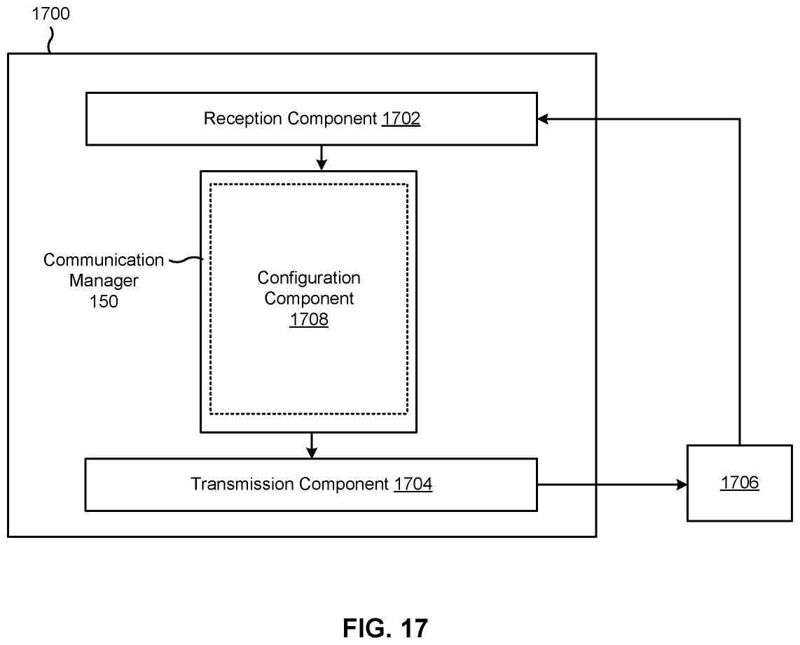

As shown in FIG. 15, in some aspects, process 1500 may include transmitting a MAC-CE updating one or more BFD-RS resources associated with at least one radio node of multiple radio nodes (block 1510). For example, the network node (e.g., using communication manager 150 and/or transmission component 1704, depicted in FIG. 17) may transmit a MAC-CE updating one or more BFD-RS resources associated with at least one radio node of multiple radio nodes, as described above.

As further shown in FIG. 15, in some aspects, process 1500 may include triggering or transmitting a BFD-RS based at least in part on the one or more BFD-RS resources (block 1520). For example, the network node (e.g., using communication manager 150 and/or transmission component 1704, depicted in FIG. 17) may trigger or transmit a BFD-RS based at least in part on the one or more BFD-RS resources, as described above. In some aspects, the network node may transmit the BFD-RS (such as using radio frequency (RF) components of the network node, if the network node is or includes an RU). In some aspects, the network node may trigger (e.g., configure, cause) an RU to transmit the BFD-RS.

Process 1500 may include additional aspects, such as any single aspect or any combination of aspects described below and/or in connection with one or more other processes described elsewhere herein.

In a first aspect, process 1500 includes transmitting configuration information configuring a first set of BFD-RS resources for a first radio node of the multiple radio nodes and a second set of BFD-RS resources for a second radio node of the multiple radio nodes.

In a second aspect, alone or in combination with the first aspect, the configuration information includes a list of sets of BFD-RS resources per radio node of the multiple radio nodes.

In a third aspect, alone or in combination with one or more of the first and second aspects, the MAC-CE includes a bitmap indicating the one or more BFD-RS resources.

The method of claim 13, wherein the MAC-CE includes one or more identifiers of the one or more BFD-RS resources.

In a fourth aspect, alone or in combination with one or more of the first through third aspects, the MAC-CE indicates whether the one or more BFD-RS resources are updated for a single radio node or for the multiple radio nodes.

In a fifth aspect, alone or in combination with one or more of the first through fourth aspects, the MAC-CE indicates a first BFD-RS resource is updated for a first radio node and a second BFD-RS resource is updated for a second radio node.

In a sixth aspect, alone or in combination with one or more of the first through fifth aspects, the MAC-CE identifies the at least one radio nodes.

In a seventh aspect, alone or in combination with one or more of the first through sixth aspects, the MAC-CE includes an indication of whether the one or more BFD-RS resources include a single BFD-RS resource or multiple BFD-RS resources.

In an eighth aspect, alone or in combination with one or more of the first through seventh aspects, the MAC-CE includes an indication of whether a candidate BFD-RS resource, associated with a particular radio node, is updated.

In a ninth aspect, alone or in combination with one or more of the first through eighth aspects, process 1500 includes transmitting configuration information indicating a configured serving cell list.

Although FIG. 15 shows example blocks of process 1500, in some aspects, process 1500 may include additional blocks, fewer blocks, different blocks, or differently arranged blocks than those depicted in FIG. 15. Additionally, or alternatively, two or more of the blocks of process 1500 may be performed in parallel.

FIG. 16 is a diagram of an example apparatus 1600 for wireless communication, in accordance with the present disclosure. The apparatus 1600 may be a UE, or a UE may include the apparatus 1600. In some aspects, the apparatus 1600 includes a reception component 1602 and a transmission component 1604, which may be in communication with one another (for example, via one or more buses and/or one or more other components). As shown, the apparatus 1600 may communicate with another apparatus 1606 (such as a UE, a base station, or another wireless communication device) using the reception component 1602 and the transmission component 1604. As further shown, the apparatus 1600 may include the communication manager 140. The communication manager 140 may include one or more of a monitoring component 1608 or an updating component 1610, among other examples.

In some aspects, the apparatus 1600 may be configured to perform one or more operations described herein in connection with FIGS. 3-13. Additionally, or alternatively, the apparatus 1600 may be configured to perform one or more processes described herein, such as process 1400 of FIG. 14 or a combination thereof. In some aspects, the apparatus 1600 and/or one or more components shown in FIG. 16 may include one or more components of the UE described in connection with FIG. 2. Additionally, or alternatively, one or more components shown in FIG. 16 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1602 may receive communications, such as reference signals, control information, data communications, or a combination thereof, from the apparatus 1606. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1600. In some aspects, the reception component 1602 may include one or more antennas, a modem, a demodulator, a MIMO detector, a receive processor, a controller/processor, a memory, or a combination thereof, of the UE described in connection with FIG. 2.

The transmission component 1604 may transmit communications, such as reference signals, control information, data communications, or a combination thereof, to the apparatus 1606. In some aspects, one or more other components of the apparatus 1600 may generate communications and may provide the generated communications to the transmission component 1604 for transmission to the apparatus 1606. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1606. In some aspects, the transmission component 1604 may include one or more antennas, a modem, a modulator, a transmit MIMO processor, a transmit processor, a controller/processor, a memory, or a combination thereof, of the UE described in connection with FIG. 2. In some aspects, the transmission component 1604 may be co-located with the reception component 1602 in a transceiver.

The reception component 1602 may receive a MAC-CE updating one or more BFD-RS resources associated with at least one radio node of multiple radio nodes associated with the UE. The monitoring component 1608 may monitor for a BFD-RS on the one or more BFD-RS resources.

The reception component 1602 may receive configuration information configuring a first set of BFD-RS resources for a first radio node of the multiple radio nodes and a second set of BFD-RS resources for a second radio node of the multiple radio nodes.

The updating component 1610 may update the one or more BFD-RS resources for a set of serving cells including at least one of a serving cell indicated by the MAC-CE, or one or more other serving cells indicated by a configured serving cell list.

The reception component 1602 may receive, prior to updating the one or more BFD-RS resources, RRC signaling indicating the configured serving cell list.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

FIG. 17 is a diagram of an example apparatus 1700 for wireless communication, in accordance with the present disclosure. The apparatus 1700 may be a network node, or a network node may include the apparatus 1700. In some aspects, the apparatus 1700 includes a reception component 1702 and a transmission component 1704, which may be in communication with one another (for example, via one or more buses and/or one or more other components). As shown, the apparatus 1700 may communicate with another apparatus 1706 (such as a UE, a base station, or another wireless communication device) using the reception component 1702 and the transmission component 1704. As further shown, the apparatus 1700 may include the communication manager 150. The communication manager 150 may include a configuration component 1708, among other examples.

In some aspects, the apparatus 1700 may be configured to perform one or more operations described herein in connection with FIGS. 3-13. Additionally, or alternatively, the apparatus 1700 may be configured to perform one or more processes described herein, such as process 1500 of FIG. 15, or a combination thereof. In some aspects, the apparatus 1700 and/or one or more components shown in FIG. 17 may include one or more components of the network node described in connection with FIG. 2. Additionally, or alternatively, one or more components shown in FIG. 17 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1702 may receive communications, such as reference signals, control information, data communications, or a combination thereof, from the apparatus 1706. The reception component 1702 may provide received communications to one or more other components of the apparatus 1700. In some aspects, the reception component 1702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1700. In some aspects, the reception component 1702 may include one or more antennas, a modem, a demodulator, a MIMO detector, a receive processor, a controller/processor, a memory, or a combination thereof, of the network node described in connection with FIG. 2.

The transmission component 1704 may transmit communications, such as reference signals, control information, data communications, or a combination thereof, to the apparatus 1706. In some aspects, one or more other components of the apparatus 1700 may generate communications and may provide the generated communications to the transmission component 1704 for transmission to the apparatus 1706. In some aspects, the transmission component 1704 may perform signal processing on the generated communications (such as filtering, amplification, modulation, digital-to-analog conversion, multiplexing, interleaving, mapping, or encoding, among other examples), and may transmit the processed signals to the apparatus 1706. In some aspects, the transmission component 1704 may include one or more antennas, a modem, a modulator, a transmit MIMO processor, a transmit processor, a controller/processor, a memory, or a combination thereof, of the network node described in connection with FIG. 2. In some aspects, the transmission component 1704 may be co-located with the reception component 1702 in a transceiver.

The transmission component 1704 may transmit a MAC-CE updating one or more BFD-RS resources associated with at least one radio node of multiple radio nodes. The transmission component 1704 may trigger or transmitting a BFD-RS based at least in part on the one or more BFD-RS resources.

The configuration component 1708 may transmit configuration information configuring a first set of BFD-RS resources for a first radio node of the multiple radio nodes and a second set of BFD-RS resources for a second radio node of the multiple radio nodes.

The configuration component 1708 may transmit configuration information indicating a configured serving cell list.

The number and arrangement of components shown in FIG. 17 are provided as an example. In practice, there may be additional components, fewer components, different components, or differently arranged components than those shown in FIG. 17. Furthermore, two or more components shown in FIG. 17 may be implemented within a single component, or a single component shown in FIG. 17 may be implemented as multiple, distributed components. Additionally, or alternatively, a set of (one or more) components shown in FIG. 17 may perform one or more functions described as being performed by another set of components shown in FIG. 17.

The following provides an overview of some Aspects of the present disclosure:

Aspect 1: A method of wireless communication performed by a user equipment (UE), comprising: receiving a medium access control (MAC) control element (MAC-CE) updating one or more beam failure detection (BFD) reference signal (BFD-RS) resources associated with at least one radio node of multiple radio nodes associated with the UE; and monitoring for a BFD-RS on the one or more BFD-RS resources.

Aspect 2: The method of Aspect 1, further comprising: receiving configuration information configuring a first set of BFD-RS resources for a first radio node of the multiple radio nodes and a second set of BFD-RS resources for a second radio node of the multiple radio nodes.

Aspect 3: The method of Aspect 2, wherein the configuration information includes a list of sets of BFD-RS resources per radio node of the multiple radio nodes.

Aspect 4: The method of any of Aspects 1-3, wherein the MAC-CE includes a bitmap indicating the one or more BFD-RS resources.

Aspect 5: The method of any of Aspects 1-3, wherein the MAC-CE includes one or more identifiers of the one or more BFD-RS resources.

Aspect 6: The method of any of Aspects 1-5, wherein the MAC-CE indicates whether the one or more BFD-RS resources are updated for a single radio node or for the multiple radio nodes.

Aspect 7: The method of any of Aspects 1-6, wherein the MAC-CE identifies the at least one radio node.

Aspect 8: The method of any of Aspects 1-7, wherein the MAC-CE includes an indication of whether the one or more BFD-RS resources include a single BFD-RS resource or multiple BFD-RS resources.

Aspect 9: The method of any of Aspects 1-8, wherein the MAC-CE includes an indication of whether a candidate BFD-RS resource, associated with a particular radio node, is updated.

Aspect 10: The method of any of Aspects 1-9, further comprising: updating the one or more BFD-RS resources for a set of serving cells including at least one of: a serving cell indicated by the MAC-CE, or one or more other serving cells indicated by a configured serving cell list.

Aspect 11: The method of Aspect 10, wherein the serving cell indicated by the MAC-CE is indicated by the configured serving cell list.

Aspect 12: The method of Aspect 10, further comprising: receiving, prior to updating the one or more BFD-RS resources, radio resource control (RRC) signaling indicating the configured serving cell list.

Aspect 13: A method of wireless communication performed by a network node, comprising: transmitting a medium access control (MAC) control element (MAC-CE) updating one or more beam failure detection (BFD) reference signal (BFD-RS) resources associated with at least one radio node of multiple radio nodes; and triggering or transmitting a BFD-RS based at least in part on the one or more BFD-RS resources.

Aspect 14: The method of Aspect 13, further comprising: transmitting configuration information configuring a first set of BFD-RS resources for a first radio node of the multiple radio nodes and a second set of BFD-RS resources for a second radio node of the multiple radio nodes.

Aspect 15: The method of Aspect 14, wherein the configuration information includes a list of sets of BFD-RS resources per radio node of the multiple radio nodes.

Aspect 16: The method of any of Aspects 13-15, wherein the MAC-CE includes a bitmap indicating the one or more BFD-RS resources.

Aspect 17: The method of any of Aspects 13-15, wherein the MAC-CE includes one or more identifiers of the one or more BFD-RS resources.

Aspect 18: The method of any of Aspects 13-17, wherein the MAC-CE indicates whether the one or more BFD-RS resources are updated for a single radio node or for the multiple radio nodes.

Aspect 19: The method of any of Aspects 13-18, wherein the MAC-CE indicates a first BFD-RS resource is updated for a first radio node and a second BFD-RS resource is updated for a second radio node.

Aspect 20: The method of any of Aspects 13-19, wherein the MAC-CE identifies the at least one radio node.

Aspect 21: The method of any of Aspects 13-20, wherein the MAC-CE includes an indication of whether the one or more BFD-RS resources include a single BFD-RS resource or multiple BFD-RS resources.

Aspect 22: The method of any of Aspects 13-21, wherein the MAC-CE includes an indication of whether a candidate BFD-RS resource, associated with a particular radio node, is updated.

Aspect 23: The method of any of Aspects 13-22, further comprising: transmitting configuration information indicating a configured serving cell list.

Aspect 24: An apparatus for wireless communication at a device, comprising a processor; memory coupled with the processor; and instructions stored in the memory and executable by the processor to cause the apparatus to perform the method of one or more of Aspects 1-23.

Aspect 25: A device for wireless communication, comprising a memory and one or more processors coupled to the memory, the one or more processors configured to perform the method of one or more of Aspects 1-23.

Aspect 26: An apparatus for wireless communication, comprising at least one means for performing the method of one or more of Aspects 1-23.

Aspect 27: A non-transitory computer-readable medium storing code for wireless communication, the code comprising instructions executable by a processor to perform the method of one or more of Aspects 1-23.

Aspect 28: A non-transitory computer-readable medium storing a set of instructions for wireless communication, the set of instructions comprising one or more instructions that, when executed by one or more processors of a device, cause the device to perform the method of one or more of Aspects 1-23.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE) for wireless communication, comprising:
a memory; and
one or more processors, coupled to the memory, configured to cause the UE to:
receive a medium access control (MAC) control element (MAC-CE) updating one or more beam failure detection (BFD) reference signal (BFD-RS) resources associated with at least one radio node of multiple radio nodes associated with the UE; and
monitor for a BFD-RS on the one or more BFD-RS resources.

2. The UE of claim 1, wherein the one or more processors are further configured to cause the UE to:
receive configuration information configuring a first set of BFD-RS resources for a first radio node of the multiple radio nodes and a second set of BFD-RS resources for a second radio node of the multiple radio nodes, wherein the one or more BFD-RS resources are included in at least one of the first set of BFD-RS resources or the second set of BFD-RS resources.

3. The UE of claim 2, wherein the configuration information includes a list of sets of BFD-RS resources per radio node of the multiple radio nodes.

4. The UE of claim 1, wherein the MAC-CE includes a bitmap indicating the one or more BFD-RS resources.

5. The UE of claim 1, wherein the MAC-CE includes one or more identifiers of the one or more BFD-RS resources.

6. The UE of claim 1, wherein the MAC-CE indicates whether the one or more BFD-RS resources are updated for a single radio node or for the multiple radio nodes.

7. The UE of claim 1, wherein the MAC-CE identifies the at least one radio node.

8. The UE of claim 1, wherein the MAC-CE includes an indication of whether the one or more BFD-RS resources include a single BFD-RS resource or multiple BFD-RS resources.

9. The UE of claim 1, wherein the MAC-CE includes an indication of whether a candidate BFD-RS resource, associated with a particular radio node, is updated.

10. The UE of claim 1, wherein the one or more processors are further configured to cause the UE to:
update the one or more BFD-RS resources for a set of serving cells including at least one of:
a serving cell indicated by the MAC-CE, or
one or more other serving cells indicated by a configured serving cell list.

11. The UE of claim 10, wherein the serving cell indicated by the MAC-CE is indicated by the configured serving cell list.

12. The UE of claim 10, wherein the one or more processors are further configured to:
receive, prior to updating the one or more BFD-RS resources, radio resource control (RRC) signaling indicating the configured serving cell list.

13. The UE of claim 1, wherein the MAC-CE includes an indication of whether the one or more BFD-RS resources are activated or deactivated.

14. A network node for wireless communication, comprising:
a memory; and
one or more processors, coupled to the memory, configured to cause the network node to:
transmit a medium access control (MAC) control element (MAC-CE) updating one or more beam failure detection (BFD) reference signal (BFD-RS) resources associated with at least one radio node of multiple radio nodes; and
trigger or transmitting a BFD-RS based at least in part on the one or more BFD-RS resources.

15. The network node of claim 14, wherein the one or more processors are further configured to cause the network node to:
transmit configuration information configuring a first set of BFD-RS resources for a first radio node of the multiple radio nodes and a second set of BFD-RS resources for a second radio node of the multiple radio nodes.

16. The network node of claim 15, wherein the configuration information includes a list of sets of BFD-RS resources per radio node of the multiple radio nodes.

17. The network node of claim 14, wherein the MAC-CE includes a bitmap indicating the one or more BFD-RS resources.

18. The network node of claim 14, The method of claim 14 wherein the MAC-CE includes one or more identifiers of the one or more BFD-RS resources.

19. The network node of claim 14, wherein the MAC-CE indicates whether the one or more BFD-RS resources are updated for a single radio node or for the multiple radio nodes.

20. The network node of claim 14, wherein the MAC-CE indicates a first BFD-RS resource is updated for a first radio node and a second BFD-RS resource is updated for a second radio node.

21. The network node of claim 14, wherein the MAC-CE identifies the at least one radio nodes.

22. The network node of claim 14, The method of claim 14 wherein the MAC-CE includes an indication of whether the one or more BFD-RS resources include a single BFD-RS resource or multiple BFD-RS resources.

23. The network node of claim 14, wherein the MAC-CE includes an indication of whether a candidate BFD-RS resource, associated with a particular radio node, is updated.

24. The network node of claim 14, wherein the one or more processors are further configured to cause the network node to:
transmit configuration information indicating a configured serving cell list.

25. The network node of claim 14, wherein the MAC-CE includes an indication of whether the one or more BFD-RS resources are activated or deactivated.

26. A method of wireless communication performed by a user equipment (UE), comprising:
receiving a medium access control (MAC) control element (MAC-CE) updating one or more beam failure detection (BFD) reference signal (BFD-RS) resources associated with at least one radio node of multiple radio nodes associated with the UE; and
monitoring for a BFD-RS on the one or more BFD-RS resources.

27. The method of claim 26, wherein the MAC-CE includes a bitmap indicating the one or more BFD-RS resources.

28. The method of claim 26, further comprising:
updating the one or more BFD-RS resources for a set of serving cells including at least one of:
a serving cell indicated by the MAC-CE, or
one or more other serving cells indicated by a configured serving cell list.

29. A method of wireless communication performed by a network node, comprising:
transmitting a medium access control (MAC) control element (MAC-CE) updating one or more beam failure detection (BFD) reference signal (BFD-RS) resources associated with at least one radio node of multiple radio nodes; and
triggering or transmitting a BFD-RS based at least in part on the one or more BFD-RS resources.

30. The method of claim 29, further comprising:
transmitting configuration information indicating a configured serving cell list.
